(19) United States
(12) Patent Application Publication
(10) Pub. No.: US 2008/0038655 A1
(43) Pub. Date: Feb. 14, 2008

(54) Toner for Developing Electrostatic Latent Image

(75) Inventor: Hiroto Kidokoro, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KIDOKORO HIROTO, TOKYO, JAPAN (JP)

(21) Appl. No.: 10/593,336

(22) PCT Filed: Mar. 14, 2005
(86) PCT No.: PCT/JP05/04455

§ 371 Date: Jun. 18, 2007

(30) Foreign Application Priority Data
Mar. 26, 2004 (JP) 2004-091140

(51) Int. Cl. G03G 9/087

(52) U.S. Cl. 430/111.4

(57) ABSTRACT

A toner for developing electrostatic latent images comprising a colored resin particle containing a binder resin, a colorant and a parting agent, and an external additive, wherein a volume average particle diameter (Dv) is 4 to 10 μm and an average circularity is in the range of 0.93 to 0.995; an arithmetic average roughness Ra of a surface of the toner is in the range of 0.05 to 0.3 μm; a 10-point average roughness of the surface of the toner is in the range of 0.5 to 2.5 μm; an angle of repose is in the range of 10 to 35°; and a transformation ratio of the toner applied with a pressure of 1 mN/mm² for 5 seconds by means of a microcompression tester is 20% or less. The toner has an excellent balance between offset and low-temperature fixing performance and an excellent shelf stability when used in a high-printing speed printer. And, by using the toner, an image can be formed without deteriorating image quality by environmental change, and excellent cleaning ability can be provided.

### TECHNICAL FIELD

The present invention relates to a toner for developing electrostatic latent image and in particular, to a toner for developing electrostatic latent image, which provides excellent balance between offset and low-temperature fixing performance and shelf stability even when used in a high-printing speed model printer, an image quality less deteriorated by environmental change, and excellent cleaning ability.

### BACKGROUND ART

An electrophotographic technology is a technology in which an electrostatic latent image is formed on a photoconductive material by various methods using a charging device, the electrostatic latent image is developed with a toner for forming a visible image, and then after transferring the visible toner image onto a transfer medium such as paper or OHP film, the transferred toner image is fixed to the transfer medium by any of various methods such as heating and pressing thereby to obtain a print.

Currently, the image forming apparatus is becoming more and more advanced for high performance and colorization and thus achievement of high speed as well as high resolution by a method of forming an electrostatic latent image by a laser is demanded. Accordingly, in addition to achieving a small particle diameter and a sharp particle diameter distribution for responding to the high resolution requirement, toners require to be fixed at low-temperature so as to react in response to high-printing speed model printers. And, in a case of a color toner such as yellow toner, magenta toner and cyan toner, organic pigments are generally used as a colorant; meanwhile, since the organic pigments are easily charged than carbon black which is used as a colorant of a black toner, a cleaning process for removing residual toners remaining on a surface of a photoconductive member after transferring becomes necessary. Today, an image forming apparatus using toners tends to be used under high temperature and high humidity areas. Accordingly, it is required for the toners to have flowability, long-period shelf stability and charging stability under high temperature and high humidity conditions.

Conventionally, a pulverized toner has been mainly in use. The pulverized toner is produced in such a manner that a thermoplastic resin including a colorant, a parting agent, a charge control agent and the like is melt-blended to be uniformly dispersed, the dispersion is pulverized into fine particles by a pulverizing mill, and then the fine pulverized particles are classified by a classification apparatus.

The pulverized toner produced by the pulverization method, however, has a difficulty in controlling particle diameter and therefore has to be subjected to a classification process which makes the production method complicate. Besides, the pulverized toner has such a problem that fine powder having a smaller diameter than the desirable toner diameter remains on the surface of the toner, in which case a charge amount of the toner may be fluctuated, resulting in lowering of image density. Furthermore, when parting agent components which melt at low temperatures may be added for achieving low-temperature fixing, the parting agent will be exposed on a surface of the toner particle, whereby it becomes difficult to obtain a toner having excellent cleaning ability and shelf stability.

In order to solve such problems, a toner producing method by various types of polymerization methods, including a suspension polymerization method, has been proposed. For instance, in the suspension polymerization method, a polymerizable monomer, a colorant and a polymerization initiator, and, if-necessary, across linkable agent, a charge control agent and other additives are uniformly dissolved or dispersed to form a monomer composition and then the monomer composition is polymerized to obtain a toner particle having a desired particle diameter. The polymerization method will provide a production of colored resin particles having a relatively narrow particle diameter distribution and containing a parting agent and a charge control agent enveloped within the particle, whereby a toner charged with a stable charge amount even under a high temperature and high humidity condition can be obtained.

As an exemplary polymerization toner, Patent Literature 1 discloses an image forming method using a toner having a 10% displacement tensile strength of 0.7 kgf/mm² or more. The toner disclosed in Example 1 of the literature is produced by a polymerization method; however, the toner has problems such as deteriorating of image quality and shelf stability when stored for a long period.

In order to respond to a high-printing speed printer, a toner capable of being fixed at low temperatures is required. For achievement of the requirement, a core-shell structured toner is proposed, which comprises a core layer covered with an outer polymer layer having a higher glass transition temperature than a polymer constituting the core layer. As such a core-shell structured toner, for example, Patent Literature 2 discloses a toner comprising a hot-melt core, containing at least thermoplastic resin and colorant, and an outer shell covering the core, in which the thermoplastic has a specified range of glass transition temperature. The literature shows that high-quality images can be formed by an image forming method using the toner. However, it is necessary to improve hot-offset balance when the toner is used in a high-printing speed model printer, shelf stability and stability of image quality subject to environmental changes.

On the contrary, in an image formation using color toners, if toner may remain on a photoconductive member after transferring, a mixing of color may be generated. So, a cleaning process for preventing such mixing of color has been discussed from various viewpoints of an image forming apparatus (an image forming method) and a toner used in the apparatus. For instance, a cleaning method in which a cleaning blade is used for scraping residual toners on a photoconductive member has been known. However, the cleaning method has a problem of deteriorating cleaning ability when a printing speed becomes high, especially when used under high temperature and high humidity conditions for a long period.

Patent Literature 3 discloses a toner comprising a colored particle, having a volume average particle diameter in the range of 5 to 8 μm, a particle diameter distribution in the range of 1.0 to 1.3 and an average sphericity obtained by dividing an area of a circle having a diameter of an absolute maximum diameter of a particle by a substantial projected area of the particle in the range of 1.0 to 1.3, and an external additive. And, the toner has an angle of repose in the range of 40 to 500 and a loose apparent specific gravity in the range of 0.3 to 0.4 g/cc. The toner disclosed in the literature has good transfer performance to a transfer medium, does not cause cleaning failure and lowering of image density and can form high-quality images without fog even under endurance printing for a long period. However, it is required to improve flowability and shelf stability and also environmental stability when used under high temperature and high humidity conditions for a long period.

Published Patent literature 1: Japanese Patent Application Laid-open Hei 6-102699,

Published Patent literature 2: Japanese Patent Application Laid-open Hei-6-324526,

Published Patent literature 3: Japanese Patent Application Laid-open 2003-295516.

### DISCLOSURE OF THE INVENTION

### Problems to be Resolved by the Invention

Accordingly, the object of the present invention is to provide a toner for developing electrostatic latent image, which provides excellent balance between offset and low-temperature fixing performance, excellent shelf stability even when used in a high-printing speed model printer, image quality less deteriorated by environmental change, and excellent cleaning ability.

The inventor of the present invention carried out an in-depth study to accomplish the object. As a result, it was found that this object can be accomplished by using a toner for developing electrostatic latent image comprising a colored resin particle containing a binder resin, a colorant and a parting agent, and an external additive, in which the colored resin particle has a volume average particle diameter in the specified range and an average circularity in a specified range and also has an arithmetic average roughness Ra of a surface of the particle in the specified range, a 10-point average roughness Rz of the surface in the specified range, an angle of repose in the specified range and a transformation ratio, measured after applying a pressure by means of a microcompression tester, in the specified range.

The present invention has been accomplished based on the above finding and provide a toner for developing electrostatic latent images comprising a colored resin particle containing a binder resin, a colorant and a parting agent, and an external additive, wherein a volume average particle diameter (Dv) is 4 to 10 μm and an average circularity is in the range of 0.93 to 0.995; an arithmetic average toughness Ra of a surface of the toner is 0.05 to 0.3 μm; a 10-point average roughness of the surface of the toner is in the range of 0.5 to 2.5 μm; an angle of repose is in the range of 10 to 35°; and a transformation ratio of the toner applied with a pressure of 1 mN/mm² for 5 seconds by means of a microcompression tester is 20% or less.

### EFFECT OF THE INVENTION

According to the present invention, a toner for developing electrostatic latent image, which provides excellent balance between offset and low-temperature fixing performance and shelf stability even when used in a high-printing speed model printer, image quality less deteriorated by environmental change, and excellent cleaning ability, can be provided.

A toner for developing electrostatic latent image according to the present invention is described in detail below.

A toner for developing electrostatic latent images according to the present invention comprises a colored resin particles and an external additive. In the present invention, the external additive typically adheres to the colored resin particles or is embedded thereon partially. And, the external additive may be partially isolated from the colored resin particles.

The colored resin particle constituting a toner for developing electrostatic latent image according to the present invention contains a binder resin, a colorant, a colorant and a parting agent, preferably, a charge control agent, and may contain other components if necessary.

As the examples of the binder resin, there can be mentioned; resins such as polystyrene, styrene-acrylic ester copolymers, polyester resins and epoxy resins, which are conventionally used for the toner.

For a black color toner, any pigments and dyes can be employed, in addition to carbon black, titanium black, magnetic powder and oil black. Carbon black having a primary particle diameter in the range of 20 to 40 nm is preferably used as a black colorant. The particle diameter within this range is preferred because such carbon black can be uniformly dispersed in the toner for developing electrostatic latent image and fog in printed image developed using the resulting toner decreases.

For a full color toner, a yellow colorant, a magenta colorant and a cyan colorant are generally used.

As the yellow colorant, there can be mentioned; compounds such as azo pigments, and condensed polycyclic pigments. Specific examples of the yellow colorant include pigments such as C.I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C.I. Pigment Blue 2, 3, 6, 15, 15:1, 15:2, 15:3, 15:4, 16, 17, and 60.

An amount of the colorant is preferably 1 to 10 parts by weight per 100 parts by weight of the binder resin.

As the charge control agent, charge control agents used in conventionally used toners can be employed without limitation. Among the charge control agents, a charge control resin is preferable, because charge control resins have high compatibility with binder resins, are colorless, and can provide a toner with a stable charging property even when it is used in high-speed, continuous color printing. As the positive charge control resin, there can be mentioned; quaternary ammonium group-containing copolymers and quaternary ammonium salt group-containing copolymers produced in accordance with the descriptions of U.S. Pat. No. 4,840,863(A), Japanese Patent Application Laid-Open Nos. Hei 3-175456, Hei 3-243954 and Hei 11-15192. And, as the negative charge control resin, there can be mentioned; sulfonic acid group-containing copolymers and sulfonic acid salt group-containing copolymers produced in accordance with the descriptions of U.S. Pat. No. 4,950,575(A) and Japanese Patent Application Laid-Open No. Hei 3-15858. When styrene-acrylic ester copolymers are employed as a binder resin, charge control resins comprising styrene copolymer are preferably used as a charge control agent from viewpoint of high compatibility.

An amount of the monomer unit having a functional group, such as a quaternary ammonium group, a quaternary ammonium salt group, a sulfonic acid group and a sulfonic acid salt group, contained in a charge control resin comprising these copolymers is preferably 1 to 12% by weight, more preferably 2 to 8% by weight, to an amount of the charge control resin. If the amount of the monomer unit is within this range, a charge amount of the toner for developing electrostatic latent image is easy to control, and a generation of fog in printed image developed using the toner can be minimized.

Preferred as the charge control resin is that having a weight average molecular weight of 2,000 to 50,000, more preferably 4,000 to 40,000, most preferably 6,000 to 35,000. If the charge control resin has a weight average molecular within the aforesaid range, occurrence of hot-offset and deteriorating of fixability may be suppressed.

A glass transition temperature of the charge control resin is preferably from 40 to 80° C., more preferably from 45 to 75° C., most preferably from 45 to 70° C. If the glass transition temperature of the charge control resin is within this range, shelf stability and fixability may be improved in a balanced manner.

An amount of the charge control agent is generally 0.1 to 10 parts by weight, preferably 1 to 6 parts by weight, per 100 parts by weight of the binder resin.

As the parting agent, there can be mentioned; polyolefin waxes such as low molecular weight polyethylene, low molecular weight polypropylene and low molecular weight polybutylene; natural plant waxes such as candelilla, carnauba, rice, wood wax and jojoba; petroleum waxes such as paraffin, microcrystalline and petrolatum, as well as waxes modified therefrom; synthetic waxes such as Fischer-Tropsch wax; and multifunctional ester compounds such as pentaerythritol tetramyristate, pentaerythritol tetrapalmitate and dipentaerythritol hexapalmitate.

The parting agent may be used alone or in combination with two or more kinds.

Among these parting agents, synthetic waxes and multifunctional ester compounds are preferred. Furthermore, multifunctional ester compounds are more preferred, which show an endothermic peak temperature within the range preferably from 30 to 150° C., more preferably from 40 to 100° C., most preferably from 50 to 80° C., measured with a DSC curve by means of a differential scanning calorimeter at rising temperature, because a toner excellent in a balance between fixing property and peeling property during fixing is obtained. In particular, those having a molecular weight of 1,000 or more and soluble in styrene at 25° C. in amount of 5 parts by weight or more per 100 parts by weight of styrene, and having an acid value of 10 mgKOH/g or less, are even more preferred, because it exhibits an effect in suppressing occurrence of hot-offset. For preferable multifunctional ester compounds, pentaerythritol-tetrapalmitate, pentaerythritol-tetramyristate, dipentaerythritol hexapulmitate and dipentaerythritol hexamyristate are given. The endothermic peak temperature refers to values measured in accordance with ASTM D3418-82.

The parting agent preferably has a hydroxy value of 0.01 to 3 mgKOH/g, more preferably 0.01 to 2 mgKOH/g. When the parting agent has a hydroxy value within the range, an image printed by a toner using the parting agent can be formed without fog. The acid value and the hydroxyl value refer to values measured in accordance with JOCS.2.3.1-96 and JOCS.2.3.6.2-96, respectively, which are standards of an oil analysis method established by JAPAN Oil Chemists' Society (JOCS).

An amount of the parting agent is generally 3 to 20 parts by weight, preferably 5 to 15 parts by weight, per 100 parts by weight of the binder resin.

And, when an addition amount of the parting agent per 100 parts by weight of the binder resin is set to “b” (unit: parts by weight) and a hydroxy value (unit: mgKOH/g) of the parting agent is set to “a”, a product (a×b) of “a” and “b” is preferably 0.05 to smaller than 40, more preferably 0.05 to smaller than 20. When a product of “a” and “b” may be set to the aforesaid range, occurrence of fog on a printed image formed by the resultant toner can be suppressed.

The colored resin particle may be a so-called core-shell structured (also called “capsule type”) particle, in which a polymer for an inner layer (a core layer) of the particle is different from a binder resin for an outer layer (a shell layer) of the particle. The core-shell structure is preferred because the type can provide a favorable balance between lowering of the fixing temperature and prevention of aggregation of the toner during shelf by covering the low softening point substance as the inner layer (core layer) with a substance having a higher softening point.

The core layer of the core-shell structured particle is composed of the aforementioned binder resin, colorant, parting agent, and, if necessary, charge control agent, while the shell layer is composed of the binder resin alone. The binder resin constituting the core layer preferably has a glass transition temperature lower than that of the binder resin constituting the shell layer.

A proportion by weight of the core layer to the shell layer of the core-shell structured particle is not particularly limited, but is generally in the range of 80/20 to 99.9/0.1.

By using the shell layer in this proportion, good shelf stability and good low temperature fixability of the toner can be fulfilled at the same time.

An average thickness of the shell layer of the core-shell type particle may be generally 0.001 to 0.1 μm, preferably 0.003 to 0.08 μm, more preferably 0.005 to 0.05 μm. The toner having a thickness within the range is preferred because fixability and shelf stability thereof are improved. The colored resin particle of the core-shell structured particle does not necessarily have all of its surface covered with the shell layer. The surface of the core particle may partly be covered with the shell layer.

A diameter of the core particle and a thickness of the shell layer of the core-shell type particle can be measured by directly measuring the diameter and thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner.

Next, the external additive constituting a toner for developing electrostatic latent images according to the present invention will be described.

The external additive constituting a toner for developing electrostatic latent images according to the present invention contains silica fine particle (A) having a primary volume average particle diameter (Dv) in the range of 5 to 18 nm, preferably 7 to 16 nm. More preferably, the external additive further contains organic fine particle (C-1) or inorganic fine particle (C-2) having a primary volume average particle diameter in the range of 0.1 to 1 μm, preferably 0.2 to 0.8 μm. Most preferably, the external additive further contains silica fine particle (B) having a primary volume average particle diameter in the range of 20 to 60 nm, preferably 25 to 50 nm. The external additive partially embedded or adhered on a surface of the colored resin particle allows control of charging property, flowability and shelf stability of the toner.

When the silica fine particle (A) and the silica fine particle (B) have a volume average particle diameter within the above range respectively, occurrence of filming on a surface of a photoconductive member will be suppressed and lowering of flowability of the resultant toner is suppressed and thus an image can be formed without thin spots.

When the organic particle (C-1) and the inorganic fine particle (C-2) having a volume average particle diameter within the above range respectively will be employed, deteriorating of abrasion property and flowability of the resultant toner may be suppressed.

The silica fine particle (A) preferably has a BET specific surface area, as measured using nitrogen gas, in the range of 10 to 80 m²/g, more preferably 20 to 60 m²/g. Use of the silica fine particle having a BET specific surface area, as measured using nitrogen gas, in the above range is preferred because a print without thin spots will be formed by a resultant toner and deteriorating of durability of the resultant toner will be suppressed.

The silica fine particle (B) preferably has a BET specific surface area, as measured using nitrogen gas, in the range of 150 to 300 m²/g, more preferably 170 to 280 m²/g. When the silica fine particle has a BET specific surface area, as measured using nitrogen gas, in the above range, a print without thin spots will be formed by the resultant toner.

A BET specific surface area, as measured using nitrogen gas, refers to a value measured by a BET adsorption method in accordance with ASTM D3037-81.

Although not limited to, the silica fine particle (A) and the silica fine particle (B) are preferably subjected to a hydrophobicitizing treatment. A hydrophobicitizing treated silica particle can be available from the market; however, can be obtained by hydrophobicitizing treating untreated silica fine particle with a treating agent such as silane coupling agent and silicone oil.

A method of the hydrophobicitizing treatment includes a process for dropping or splaying silicone oil as a treating agent to untreated silica fine particle while stirring the untreated silica fine particle at a high speed; a process for dissolving a treating agent in an organic solvent, adding silica fine particle to the organic solvent while stirring the organic solvent, mixing the organic solvent and the silica fine particle and then heat-drying. In the former process, the treating agent may be diluted with an organic solvent and the like for employment.

A degree of hydrophobicity, as measured by a methanol test, is preferably 20 to 90%, more preferably 40 to 80%. If a degree of hydrophobicity is within the range, the resultant toner hardly absorbs moisture under high temperature and high humidity conditions and will have sufficient abrasion property.

The organic fine particle (C-1) is not limited to; however, a compound constituting the organic fine particle generally has a glass transition temperature or a melting point in the range of 80 to 250° C., preferably 90 to 200° C., in order to suppress blocking of the toners. As a compound constituting the preferable organic fine particle, methyl methacrylate copolymer and styrene-methyl methacrylate copolymer are given. The inorganic fine particle (C-1) generally has a sphericity (Sc/Sr) (a value obtained by dividing an area (Sc) of a circle having an absolute maximum diameter of a particle by a substantial projected area (Sr) of the particle), not limited to, in the range of 1 to 1.3, preferably 1 to 1.2. A sphericity within the range allows suppression of deteriorating of transfer ability of the toner.

As the inorganic fine particle (C-2), silica other than the aforesaid silica fine particle (A) and silica fine particle (B), titanium oxide, aluminum oxide, zinc oxide, tin oxide, barium titanate, strontium titanate and conductive particle produced by surface-treating these particles with tin or antimony, are given.

An addition amount of the silica fine particle (A) is not limited to; however, is generally 0.1 to 3 parts by weight, preferably 0.2 to 2 parts by weight, per 100 parts by weight of the colored resin particle. When the silica fine particle (A) is added in an amount within the aforesaid range, an image without thin spots and fog can be formed by the resultant toner.

An addition amount of the silica fine particle (B) is not limited to; however, is generally 0.1 to 2 parts by weight, preferably 0.2 to 1.5 parts by weight, per 100 parts by weight of the colored resin particle. When the silica fine particle (B) is added in an amount within the aforesaid range, occurrence of filming of the resultant toner can be suppressed and an image without thin spots can be formed by the resultant toner.

An addition amount of the organic fine particle (C-1) and the inorganic fine particle (C-2) is not limited to; however, is generally 0.1 to 2 parts by weight, preferably 0.2 to 1 parts by weight, per 100 parts by weight of the colored resin particle. When the organic fine particle (C-1) and the inorganic fine particle (C-2) are added in an amount within the aforesaid range, occurrence of filming of the resultant toner can be suppressed and an image without thin spots can be formed by the resultant toner.

In a toner for developing electrostatic latent images according to the present invention, the external additive may contain another external additives, which are used in a conventionally used toner for developing electrostatic latent images as an external additive, in addition to the silica fine particle (A), the silica fine particle (B), the organic fine particle (C-1) and the inorganic fine particle (C-2).

A toner for developing electrostatic latent image according to the present invention preferably has a volume average particle diameter Dv in the range of 4 to 10 μm, preferably 5 to 8 μm. When the toner has a Dv under 4 μm, flowability of the toner mayflower, causing fog on a printed image formed by the toner. On the contrary, when the toner has a Dv larger than 10 μm, image-reproducibility and dot-reproducibility may deteriorate.

A toner for developing electrostatic latent image according to the present invention preferably has a ratio (Dv/Dp) of the volume average particle diameter (Dv) to a number average particle diameter (Dp) in the range of 1.0 to 1.3, more preferably 1.0 to 1.2. If the Dv/Dp is within this range, occurrence of fog on a printed image formed by the resultant toner may be suppressed.

A toner for developing electrostatic latent image according to the present invention has an average circularity, as measured using a flow particle image analyzer, in the range of 0.93 to 0.995, preferably from 0.95 to 0.995. When the colored resin particle has an average circularity under this range, dot-reproducibility and cleaning ability may deteriorate.

Producing a toner for developing electrostatic latent image by means of a phase-transfer emulsion process, a solution suspension process, or a polymerization process (suspension polymerization process, emulsion polymerization method) and the like makes it possible to set the average circularity within the range easily.

In the present invention, the circularity is defined as a ratio of a perimeter of a circle having the same projected area as that of the particle image to a perimeter of the projected area of the particle. And, an average circularity in the present invention is used as a conventional method for quantitatively presenting a shape of a particle, and is an index for showing a degree of surface roughness of a toner. If a toner is perfectly spherical, the average circularity equals to 1. And, the larger the roughness of a toner is, the smaller the average circularity is. The average circularity (Ca) is calculated using the following formula.

$$Ca = ( {\sum }_{i = 1}^{n} ( Ci \times fi ) ) / {\sum }_{i = 1}^{n} ( fi )$$

In the above formula, n represents the number of particles used for calculating the circularity Ci.

In the above formula, Ci represents the circularity of each particle in a group of particles having a circle equivalent diameter of 0.6 to 400 μm, which is calculated by the following formula from the measured circuit length of each particle.

Circularity (Ci)=a perimeter length of a circle having the same area with a projected area of a particle/a perimeter length of the projected area of the particle.

In the above formula, fᵢ represent a frequency of particle having circularity Cᵢ.

The circularity and the average circularity of a toner for developing electrostatic latent images may be measured with flow particle projection image analyzers, such as “FPIA-2100” (trade name) or “FPIA-2000” (trade name), manufactured by Sysmex Corporation.

A toner for developing electrostatic latent images according to the present invention has an arithmetic roughness Ra of a surface of the toner in the range of 0.05 to 0.3 μm, preferably 0.1 to 0.25 μm. When a toner has an arithmetic average roughness Ra under the range, offset temperature may lower and cleaning ability may deteriorate. On the contrary, when a toner has an arithmetic average roughness larger than the range, dot-reproducibility may deteriorate and a minimum fixing temperature may heighten.

In the present invention, an arithmetic average roughness Ra is defined according to JIS B 0601 and measured as follows. First, from a roughness curve of a surface to be measured, a curve having a standard length in the direction of an average line of the curve is selected. And, the selected roughness curve is expressed as y=f(x) on a coordinate of X-axis in the direction of an average line of the selected roughness curve and Y-axis in the direction of longitudinal magnification. The arithmetic average roughness Ra is obtained by the following expression and shown by μm. The arithmetic average roughness Ra is measured by the later described manner.

$$Ra = \frac{1}{L} {\int }_{0}^{L} \vert f ( x ) \vert ⅆ x$$

In the expression, L represents the standard length.

A toner for developing electrostatic latent images according to the present invention has a 10-point average roughness of a surface of the toner in the range of 0.5 to 2.5 μm, preferably 0.5 to 2 μm. When a toner has a 10-points average roughness under the range, shelf stability and environmental durability may deteriorate. On the contrary, when a toner has a 10-points average roughness larger than the range, dot-reproducibility may deteriorate and a minimum fixing temperature may become high.

In the present invention, a 10-point average roughness Rz is defined in accordance with JIS B 0601 and measured as follows. First, from a roughness curve of a surface to be measured, a curve having a standard length in the direction of an average line of the roughness curve is selected. And, in the selected roughness curve, absolute distances of five highest peaks from the average line are averaged and absolute distances of five lowest peaks from the average line are averaged. Then, the obtained highest average and the obtained lowest average are added to provide a 10-point average roughness shown by am. The 10-point average roughness is measured by the later described manner.

A toner for developing electrostatic latent images according to the present invention has an angle of repose in the range of 10 to 350, preferably 10 to 300. An angle of repose is one of indexes showing flowability of a toner; that is, the smaller the angle of repose is, the higher the flowability of the toner is (The toner is not so sticky as to flow easily without jamming). When a toner has an angle of repose larger than 35°, shelf stability of the toner may deteriorate. On the contrary, when a toner has an angle of repose smaller than 10°, cleaning property may deteriorate. An angle of repose of a toner can be measured, for example, by means of a powder tester (“POWDER TESTER PT-R”, trade name, manufactured by Hosokawa Micron Corporation).

A toner for developing electrostatic latent images according to the present invention has a transformation ratio, measured after applying a pressure of 1 mN/mm² by means of a microcompression tester for 5 seconds, of 20% or less, preferably 15% or less. When the toner has a transformation ratio over the range, shelf stability of the toner may deteriorate.

The transformation ratio can be obtained as follows. When one particle of toner is applied with a load by means of a plane indenter having a diameter of 50 μm made of diamond as an upper pressure indenter and a SKS (alloy tool steel) plate as a lower indenter under a condition of a temperature of 25° C. and a humidity of 50%, a compressive transformation of the particle caused by the pressure is measured.

The transformation ratio can be measured, for instance, by microcompression testers “MCTM-200” (trade name) or “MCTM-500” (trade name), manufactured by SHIMADZU CORPORATION.

A toner for developing electrostatic latent images according to the present invention preferably has an absolute zeta potential (E1) in the range of 0 to 40 mV, more preferably from 0 to 30 mV, after allowed to stand under a condition of a temperature of 23° C. and a humidity of 50% for 24 hours. If a zeta potential is within the range, an image with high image density and less fog can be formed by the toner.

In addition, a toner for developing electrostatic latent image according to the present invention has a difference between an absolute zeta potential (E2) of the toner after allowed to stand under a condition of temperature of 50° C. and a humidity of 80% for two weeks and E1, of 5 mV or less, more preferably 3 mV or less. If the difference between E2 and E1 is within the range, an image without fog can be formed by the toner.

A zeta potential is measured by means of, for example, a laser Doppler system known as an electrophoretic light scattering measurement system. When particles dispersed in a liquid are charged, applying voltage to the system causes the particles to move toward an electrode at a moving velocity proportional to the charge amount of the particles. Therefore, measurement of the moving velocity of the particles allows obtaining a zeta potential. In the laser Doppler system, “Doppler effect”, in which when a light or a sonic wave is hit on an moving object and then reflected thereon or scattered, a frequency of the light or the sonic wave is changed according to a velocity of the moving object, is employed for obtaining an electrophoretic velocity (moving velocity) of the particles. When electrophoretic particles are irradiated with a laser beam, a frequency of the scattered light from the particles is sifted due to Doppler effect. And, since the amount of the frequency shift is proportional to the electrophoretic velocity of the particles, measuring the amount of the frequency shift can provide the electrophoretic velocity of the particles.

From the obtained electrophoretic velocity (V) and the electric field (E), an electrical mobility (U) is obtained using the following expression (1).
U=V/E (1)

From the electrical mobility (U), a zeta potential (ζ) is obtained using the following expression (2) (Smoluchowski's expression).
ζ=4πηU/∈ (2)

In the expression (2), η and ∈ show as follows,

η: a viscosity of a solvent;

∈: a dielectric constant of the solvent.

In this description, in order to obtain a zeta potential, a mixed solvent (50/50:capacity standard, at 25° C.) of ethanol and ion-exchanged water is employed. η is 0.993 mPa, ∈ is 52.0.

A value of the zeta potential is a function of the viscosity and the dielectric constant of the solvent as mentioned above. Since the value of the zeta potential is easily affected by ion contained in the solvent or pH of the solvent, the zeta potential is measured under conditions within the range of pH6.5 to 7.5. The ion-exchanged water employed for measuring the zeta potential preferably has an electric conductivity of 10 μS/cm or less, more preferably 1 μS/cm or less. In order to measure a zeta potential of the toner for developing electrostatic latent images correctly, it is necessary to employ a solvent capable of wetting a surface of the toner sufficiently without adhering air bubbles on the surface of the toner when the toner is mixed with the solvent. If air bubbles may adhere on the surface of the toner, a mixture of the toner for developing electrostatic latent images and the solvent is preferably subjected to an ultrasonic treatment in order to improve wettability of the toner with a solvent.

A toner for developing electrostatic latent images according to the present invention preferably has a glass transition temperature in the range of 50° C. or higher to lower than 70° C., more preferably 53° C. or higher to lower than 65° C. When a toner has a glass transition temperature within the range, hot-offset temperature may move to higher and thus fixing temperature may move lower.

The colored resin particle constituting a toner for developing electrostatic latent image according to the present invention may be produced by any methods for producing a toner having the aforesaid properties; however, not limited to, is preferably produced by a polymerization method, especially a suspension polymerization method.

Next, a method for producing the colored resin particles by the polymerization method will be described.

The colored resin particle constituting a toner for developing electrostatic latent image according to the present invention is produced such that a crosslinkable monomer (having a relatively large molecular weight), a colorant, a charge control agent, a parting agent, a chain transfer agent and other additives are dissolved or dispersed in a polymerizable monomer (necessarily containing a monovinyl monomer) which is a raw material of the binder resin (the resultant mixture is called a polymerizable monomer composition). Then, the mixture is polymerized in an aqueous dispersing medium containing a dispersion stabilizer to which a polymerization initiator is added and then subjected to filtrating, washing, dehydrating and drying. In a toner for developing electrostatic latent images, the colored resin particle is produced by controlling a kind and an amount ratio of the polymerizable monomer, a kind and an amount of the crosslinkable monomer, an amount of the chain transfer agent, a hydroxy value and an amount of the parting agent and a kind and an amount of the polymerization initiator, and external additives comprising plural particles are added so that then toner will have a specified arithmetic average roughness Ra, a specified 10-point average roughness Rz, a specified angle of repose and a specified transformation ratio to the specified ranges according to the present invention.

As a polymerizable monomer, there can be mentioned, for instance, a monovinyl monomer, in addition, a crosslinkable monomer and a macromonomer may be used together. These polymerizable monomers become the binder resin component after polymerization.

Specific examples of the monovinyl, monomers include; aromatic vinyl monomers such as styrene, vinyltoluene and α-methylstyrene; acrylic ester monomers such as acrylic acid, methyl acrylate, ethyl acrylate, propyl acrylate, butyl acrulate, 2-ethylhexyl acrylate, cyclohexyl acrylate and isobonyl acrylylate; methacrylic ester monomers such as methacrylic acid, methyl methacrylate, ethyl methacrylate, propyl methacrylate, butyl methacrylate, 2-ethlhexyl methacrylate, cyclohexyl methacrylate and isobonyl methacrylylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic ester monomers or methacrylic ester monomers.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; divinylbenzene, divinylnaphthalene, ethlenglycol dimethacrylate, pentaerythritol triallyl ether and trimethylolpropane triacrylate. These crosslinkable monomers may be used alone or in a combination thereof. An amount of the crosslinkable monomer is generally 10 parts by weight or less, preferably 0.1 to 2 parts by weight, per 100 parts by weight of the monovinyl monomer.

It is preferable to use a macroinonomer together with the monovinyl monomer because this use provides a satisfactory balance between shelf stability and fixability at a low temperature. The macromonomer is an oligomer or polymer having a polymerizable carbon-carbon unsaturated double bond at its molecular chain terminal and a number average molecular weight of generally from 1,000 to 30,000.

The macromonomer is preferably the one which gives a polymer having a glass transition temperature higher than that of a polymer obtained by polymerizing the above-mentioned monovinyl monomer alone.

An amount of the macromonomer used is generally 0.01 to 10 parts by weight, preferably 0.03 to 5 parts by weight, more preferably 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), 2,2′-azobis-(2-methyl-N-(2-hydroxyethyl))propionamide, 2,2′-azobis-(2-amidinopropane)dihydrochloride, 2,2′-azobis-(2,4-dimethyl valeronitrile) and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used.

An amount of the polymerization initiator is preferably 0.1 to 20 parts by weight, more preferably 0.3 to 15 parts by weight, most preferably 0.5 to 10 parts by weight, per 100 parts by weight of the polymerizable monomer. The polymerization initiator may be added to the polymerizable monomer composition in advance or may be added to an aqueous dispersion medium after forming droplets depending on conditions.

Moreover, at the time of polymerization, a dispersion stabilizer may be added to the aqueous dispersing medium. As the dispersion stabilizer, there can be mentioned; an inorganic salt such as barium sulfate, calcium sulfate, calcium carbonate, magnesium carbonate and calcium phosphate; an inorganic oxide such as aluminum oxide and titanium oxide; an inorganic compound such as aluminium hydroxide, magnesium hydroxide and ferric hydroxide; a water-soluble polymers such as polyvinyl alcohol, methyl cellulose and gelatin; anionic surfactants; nonionic surfactants; and amphoteric surfactants. The aforesaid dispersion stabilizer may be used alone or in combination of two kinds thereof.

In a suspension polymerization method, among the above dispersion stabilizers, a dispersion stabilizer containing colloid of the metallic compound, especially a hardly water-soluble inorganic hydroxide, is preferred, since it can narrow the particle size distribution of a polymer particles; the remaining amount of the dispersion stabilizer after washing is small; and it can sharply reproduce images.

An amount of the above dispersion stabilizer is preferably 0.1 to 20 parts by weight per 100 parts by weight of the polymerizable monomer. The amount of the dispersion stabilizer within this range is preferred because the polymerization reaction is stably performed and a formation of polymerization aggregate is suppressed.

Further, upon polymerization, a molecular weight modifier is preferably used. As the molecular weight modifier, there can be mentioned; mercaptans such as t-dodecylmercaptan, n-dodecyl mercaptan, n-octyl mercaptan and 2,2,4,6,6-pentamethylheptane-4-thiol and the like. Of the above mercaptans, 2,2,4,6,6-pentamethylheptane-4-thiol is preferable. The molecular weight modifier may be added before or during polymerization reaction. An amount of the molecular weight modifier is preferably 0.01 to 10 parts by weight, more preferably 0.1 to 5 parts by weight, per 100 parts by weight of the polymerizable monomer.

A method for producing the core-shell structured colored resin particles is not limited, and these colored resin particles can be produced by a publicly known method. For example, a method such as spray-drying method, interfacial reaction method, in-situ polymerization method, or phase separation method may be named. Specifically, colored resin particles obtained by pulverization, polymerization, association or phase inversion emulsification as core particles are covered with a shell layer to prepare core-shell structured colored resin particles. Of these methods, the in-situ polymerization method and phase-separation method are preferable because of their efficient productivity.

The method for producing the core-shell structured colored resin particles using the in-situ polymerization process is described below.

A polymerizable monomer to form a shell (a polymerizable monomer for shell) and a polymerization initiator are added to an aqueous dispersion medium including core particles dispersed therein, and the mixture is polymerized to obtain the core-shell structured colored resin particles.

As specific examples of the process for forming the shell, there can be mentioned; a process comprising adding a polymerizable monomer for a shell to a reaction system of a polymerization reaction which has been conducted for preparing core particles to continuously conduct polymerization; and a process comprising introducing core particles prepared in a different reaction system and adding a polymerizable monomer for a shell thereto to conduct polymerization.

The polymerizable monomer for shell may be added to the reaction system at one time, or may be added continuously or dividedly using a pump such as a plunger pump.

As the polymerizable monomer for shell, monomers capable of forming a polymer having a glass transition temperature of higher than 80° C. by polymerization, such as styrene, acrylonitrile and methyl methacrylate, may be used alone or in a combination thereof. In addition, it is preferable to use in ethacrylate modified silicone oil in combination with the monomers because excellent shelf stability and cleaning property can be provided to a toner. The methacrylate modified silicone oil is one that takes advantage of dimethyl polycyclohexane and combines methacrylic acid to a part of methyl group thereof.

When the polymerizable monomer for shell is added to the reaction system, a water-soluble polymerization initiator as a polymerization initiator for polymerizing the polymerizable monomer for shell is preferably added, because this addition makes it easy to obtain the core-shell type colored particles. It is speculated that when the water-soluble polymerization initiator is added during addition of the polymerizable monomer for shell, the water-soluble polymerization initiator migrates to a zone surrounding the surface of the core particle, the zone where the polymerizable monomer for shell has moved, so that a polymer (shell) is easily formable on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1′-bis(hydroxymethyl)-2-hydroxyethyl)propionamide. An amount of the water-soluble polymerization initiator is generally 0.1 to 30 parts by weight, preferably 1 to 20 parts by weight, per 100 parts by weight of the polymerizable monomer for shell.

A temperature during the polymerization is preferably 50° C. or higher, more preferably 60 to 95° C. A polymerization reaction period is preferably 1 to 20 hours, more preferably 2 to 10 hours. After completion of the polymerization, a procedure for filtrating, washing, dehydrating and drying obtained core-shell structured resin particles is preformed in accordance with the conventional methods. If necessary, washing and dehydrating are preferably repeated several times.

In the aqueous dispersion of the colored resin particles obtained by the polymerization, if an inorganic compound such as inorganic hydroxide is used as the dispersion stabilizer, the dispersion stabilizer is preferably dissolved in water and removed by adding acid or alkali. If a colloid of a hardly water-soluble inorganic hydroxide is used as the dispersion stabilizer, it is preferable to add acid so that pH of the aqueous dispersion is pH6.5 or lower. As the acid to be added, an inorganic acid such as sulfuric acid, hydrochloric acid or nitric acid; or an organic acid such as formic acid or acetic acid; can be used. Sulfuric acid is particularly preferable because it has a high efficiency of its removal and its burden on production facilities is light.

There is no limitation on the method of filtering toner particles from the aqueous dispersion medium for dehydration. For example, centrifugal filtration, vacuum filtration or pressurized filtration can be named. Of these methods, centrifugal filtration is preferable.

The toner for developing electrostatic latent image according to the present invention is obtained by mixing the colored resin particles and the external additive and, if desired, other fine particles by means of a high-speed stirrer such as a Henschel mixer.

### EXAMPLE

The present invention is hereinafter to be described more specifically by the following examples. Such examples, however, are not to be construed as limiting in any way the scope of the present invention. All designations of “part” or “parts” and “%” used in the following examples mean part or parts by weight and wt. “%” unless expressly noted.

In this example, a toner for developing electrostatic latent image is evaluated using the following methods.

(1) Volume Average Particle Diameter and Particle Diameter Distribution

A volume average particle diameter (Dv) and a particle diameter distribution, i.e., a ratio (Dv/Dp) of the volume average particle diameter to a number average particle diameter (Dp), of a toner for developing electrostatic latent images were measured by means of a particle diameter measuring device “MULTISIZER” (trade name, manufactured by Beckman Coulter, Inc.). The measurement by the Multisizer was conducted under the following conditions:

Aperture diameter: 100 μm;

Medium: Isothone II;

Concentration: 10% and

Number of particles measured: 100,000 particles.

(2) Average Circularity

To 20 mg of a toner for developing electrostatic latent images, 100 μl of 0.1% sodium dodecyl sulfonate (anion surfactant) aqueous mixture was added and blended with the toner. Then, 10 ml of ion-exchanged water was added to the mixture and subjected to a dispersing processing using an ultrasonic dispersion apparatus of 60 W for 30 minutes. A toner concentration at a measurement was adjusted to 3,000 to 10,000 μL, and then 1,000 to 10,000 of toners having a circle equivalent diameter of 1 μm or more were used for measurement using a flow type particle image analyser “FPIA-2100” (trade name) manufactured by SYSMEX CORPORATION. From the measurement, an average circularity was obtained.

(3) Arithmetic Average Roughness Ra and 10-Point Average Roughness Rz

A toner for developing electrostatic latent images were placed on a sampling plate and excess of the toner for developing electrostatic latent image was removed by a blower. And, toners having a diameter near a volume average particle diameter were selected from the toner placed on the sampling plate and a surface 4 μm in length of the toner was measured for a roughness curve by means of a violet color laser microscope (“VK-9500”, trade name, manufactured by KEYENCE CORPORATION). The measurement was carried out at 150 times magnification, 20 times of optical zoom, 0.05 μm of pitch and cutoff curvature of 0.08 mm. Then, a three-dimensional surface profile analysis software (“SurftopEye”, trade name, manufactured by Mitani Corporation) was employed for obtaining an arithmetic average roughness Ra and a 10-point average roughness Rz. And, five particles of the toner were measured for Ra and Rz and an average of each Ra and Rz were set to a Ra value and a Rz value.

(4) Angle of Repose

An angle of repose of toner was measured by means of a powder tester (“Powder Tester PT-R”, trade name, manufactured by Hosakawa Micron Corporation). A sample funnel was set on a stand of the tester, and a standard sieve having an opening size of 60 mesh was placed and fixed on the sample funnel. Then, the sample funnel was vibrated such that toner for developing electrostatic latent images set on the sieve were dropped through the sample funnel on a circular table of 8 cm in diameter to form a heap of the toner for developing electrostatic latent images. And, an angle between a horizontal table surface and a ridgeline of the toner heap was measured with a laser beam and defined as an angle of repose of the toners. During the vibration of the sample funnel, a dropping speed of the toner for developing electrostatic latent images was adjusted by adjusting amplitude of the vibration in such a manner that the heap of the toner would not break.

(5) Microcompression Transformation Ratio

A toner for developing electrostatic latent images was placed on a sample plate and excess of the toner was removed by a blower. Under a condition of a temperature of 25° C. and a humidity of 50%, by using a microcompression tester (“MCTM-500”, trade name, manufactured by SHIMADZU CORPORATION), the toner having a particle diameter of αμm was applied with a pressure of 1 mN/mm² for 5 seconds and measured for a press depth. The measurement was carried out for 5 times. The average of the three remaining results excluding the maximum and the minimum was defined as a press depth βμm of the toner for developing electrostatic latent images. A microcompression transformation ratio of one of the toner for developing electrostatic latent images was calculated from the following expression.
A microcomporession transformation ratio=(β/α)×100.

In the same way, a total ten of the toner for developing electrostatic latent images was measured for the microcompression transformation ratio and the results was averaged to set to a microcompression transformation ratio.

(6) Zeta Potential

To 30 mg of a toner for developing electrostatic latent images which allowed to stand for 24 hours under a condition of a temperature of 23° C. and a humidity of 50%, a solvent of ethanol and ion-exchanged water (a conductivity: 0.8 μS/cm) having a volume ratio of 50:50 was added until a total weight was 100 g, and then the toner was dispersed in the solvent using an ultrasonic dispersion apparatus for 5 minutes. Then, a zeta potential of the solution was measured using a zeta potential measurement apparatus (“zetasizer3000HS”, trade name, manufactured by Malvern Instrument Ltd.) at 25° C.

A zeta potential of the toner for developing electrostatic latent images, which was measured just after dispersing in the solvent, was set to E1. On the other hand, a zeta potential of the toner, which was measured after allowed to stand under a condition of a temperature of 50° C. and a humidity of 80% for two weeks by the same manner as the aforesaid E1, was set to E2.

(7) Glass transition Temperature

In accordance with JIS K7121, a glass transition temperature was measured by using a differential scanning calorimetry (“RDC-220”, trade name, manufactured by Seiko Instruments Inc.). 6 to 8 mg of a toner for developing electrostatic latent images was weighed and charged into a sample container. Then, the toner was heated at a heating rate of 10° C./minute to 130° C. from −10° C. under nitrogen gas atmosphere to obtain a DSC curve. From the DSC curve, a minimum glass transition temperature was obtained and defined as a glass transition temperature of the toner for developing electrostatic latent images.

(8) Fixing Temperature

A fixing test was conducted using a commercially available non-magnetic-one-component developing type printer (a printing speed: 28 sheet/min) modified such that the temperature of its fixing roll portion would be variable. The fixing test was performed by varying the temperature of the fixing roll of the modified printer by 5° C. at a time, and measuring the fixing rate of the developer at each temperature to determine a relationship between a temperature and a fixing rate. The fixing rate was calculated from the ratio of image density after a tape peeling treatment to that before the treatment in a black solid printing area (an area of which whole region was printed with toner) in a test sheet printed by the modified printer. That is, the fixing rate was calculated from the following equation:
Fixing rate(%)=(ID_{After}/ID_{Before})×100
where ID_{Before} represents the image density before tape peeling, and ID_{After} represents the image density after tape peeling.

The tape peeling treatment means a series of steps consisting: applying an adhesive tape (Scotch Mending Tape 810-3-18, trade name, manufactured by Sumitomo 3M Limited) to a portion of the test sheet to be evaluated, pressing the adhesive tape at a constant pressure, and then peeling the adhesive tape at a constant speed in a direction along the sheet. The image density was measured by use of a Macbeth's reflection type image density measuring device. The toner fixing temperature denotes the temperature of the fixing roll at which the fixing rate became 80% in the fixing test. A toner having a lower fixing temperature is superior because the toner has a low-temperature fixability and thus can be used in a high-printing speed model printer.

(9) Hot-Offset Temperature

As in the measurement of the toner fixing temperature in test (8), the temperature of the fixing roll was varied by 5° C. at a time, and printing was done at each temperature. Hot-offset resistance denotes the minimum temperature at which the toner becomes to remain on the fixing roll to generate soil. A toner having a higher hot-offset temperature is superior because the toner has a hot-offset resistance and thus can be used in a high-printing speed model printer.

(10) Image Density

Copy papers were set in a commercially available non-magnetic-one-component developing type printer (a printing speed: 28 sheet/min), and a toner for developing electrostatic latent images was put in a developing device of the printer and an amount of the toner supplied on a developing roll of the printer was adjusted to 0.45 mg/cm² (constant). The toner was left standing for 24 hours under an (N/N) environment of a temperature of 23° C. and a humidity of 50%. Then, printing was continuously performed at an image density of 5%. And then, a solid image printing (a printing a whole region of a paper with toner) was preformed every 10 papers printing. And, an image density of the printed solid image was measured using a Macbeth's reflection type image density measuring device. On the contrary, after leaving the toner for developing electrostatic latent images under a condition of a temperature of 50° C. and a humidity of 80% for 2 weeks, the toner was put in the developing device and measured for an image density in the same way.

(11) Environmental Durability

The printer used in (10) was left standing for 24 hours under each condition of a (N/N) condition of a temperature of 23° C. and a humidity of 50% and a (H/H) condition of a temperature of 35° C. and a humidity of 80%. Printing was continuously performed at an image density of 5%. And, at every 500 papers printing, a solid pattern printing and a plain pattern printing (a printing a whole region of a paper without toner) were carried out.

A printed solid pattern image was measured for an image density in the same way as (9).

And, after the plain pattern printing, the toner on the photoconductive member after developing was adhered to an adhesive tape (Scotch Mending Tape 810-3-18, trade name, manufactured by Sumitomo 3M Limited). Then, the adhesive tape was stuck on a new sheet of paper to measure a color tone (B) using a spectroscopic color-difference meter (“SE2000”, trade name, manufactured by Nippon Denshoku Industries Co., Ltd.). At the same time, an unused adhesive tape was stuck on the same new sheet of paper to measure a color tone (A). Then, the color tones were shown on a L*a*b* space coordinates, and a color difference ΔE* was calculated by the two color tones to obtain a fog value. As the fog value is small, fog generated on a printed image is small.

Environmental durability was evaluated by checking a number of the continuously printed paper capable of keeping an image quality of an image density of 1.3 or more and an fog value of 1% or less. Final number of the paper was set to 10,000. The samples having 10,000 in a table show that the aforesaid image quality is kept even after 10,000 papers printing.

(12) Shelf Stability

About 20 g of the toner for developing electrostatic latent image was weighed, and charged into a sealable container and then sealed. And, the toner was allowed to stand for 2 weeks under a condition of a temperature of 50° C. After 2 weeks, the toner was transferred onto a sieve having an opening diameter of 500 μm from the container. In this procedure, the toner was taken out of the container so as not to destroy the aggregate structure of the toner and carefully transferred to the sieve. The sieve on which the toner was transferred was vibrated by means of the powder tester used in (4) under a condition of a vibration amplitude of 1.0 mm for 30 seconds. Then, the weight of the toner remaining on the sieve was measured, and the measured value was defined as a weight of an aggregated toner. A proportion of the weight (wt. %) of the aggregated toner to a weight of the toner initially placed in the container was calculated. The measurement was made three times for one sample, and the average of the measured values was obtained and used as an index of shelf stability. The shelf stability of the toner is better as it shows a smaller value (wt. %).

(13) Cleaning Property

A commercially available non-magnetic-one-component developing type printer (a printing speed: 28 sheet/min) was modified such that a cleaning blade was mounted and a copy paper was set to the cleaning blade as a transfer medium. After the toner for developing electrostatic latent images was put in the developing device of the printer and allowed to stand for 24 hours under a (N/N) environment of a temperature of 23° C. and a humidity of 50%, printing was continuously performed at an image density of 5%. Every 500 printing, the photoconductive member and the charging roll were observed in order to count the number of papers at which cleaning failure was generated thereon. The observation was performed until 10,000 papers printing at the maximum. In the table, “more than 10,000” means no, cleaning failure at 10,000 papers printing.

### Production Example 1

100 parts of dipentaerythritol (“D-PE”, trade name, manufactured by KOEI CHEMICAL CO., LTD.) and 567 parts of myristic acid were charged into a four-opening flask equipped with a thermometer, a nitrogen introduction pipe, an agitating blade and a cooling pipe, and reacted for 15 hours at normal pressures at 220° C. under an airflow of nitrogen gas while removing water of reaction. And, to 625 parts of the obtained crude product, 187 parts of toluene, 31 parts of n-propanol and 100 parts of a solution of 8% potassium hydroxide in water were added and stirred for 30 minutes at 70° C. After the stirring, the products was left at rest for 30 minutes to be separated into a water phase and an oil phase, and then the water phase was removed from the oil phase. Consequentially, an operation (a water washing) in which 20 parts of ion-exchanged water was added to 100 parts of the obtained crude products, and after stirring for 30 minutes at 70° C., the product was left at rest for 30 minutes and then the water phase was removed was performed. The water washing was repeated for 4 times until a pH value of the water phase was changed to neutral. After the water washings, from the oil phase obtained by the separation, toluene and n-propanol were removed under reduced pressure of 1 kPa at 180° C. and then the oil phase was filtered to obtain crude dipentaerythritol hexamyristate (a hydroxy value: 2.9 mgKOH/g). The crude dipentaerythritol hexamyristate has a solubility to toluene at 40° C. in an amount of 30 wt %.

Then, the above crude dipentaerythritol hexamyristate was dissolved in toluene heated at 40° C. to prepare a solution of 20 wt % dipentaerythritol hexamyristate. And, the solution was cooled to 5° C. and recrystallized. With maintaining the temperature at 5° C., the recrystallized components was filtered by a filter paper and the recrystallized component on the filter paper was vacuum-dried for 24 hours at 50° C. to obtain ester compound (purified dipentaerythritol hexamyristate) employed as a parting agent. The ester compound has a solubility to toluene at 40° C. in an amount of 20 wt %, a solubility to toluene at 40° C. in an amount of 30 wt % and a hydroxy value of 0.6 mgKOH/g.

### Example 1

80.5 parts of styrene, 19.5 parts of n-butylacrylate, 0.5 parts of polymethacrylate ester macromonomer (“AA6”, trade name, manufactured by Toagosei CO., LTD.), 0.6 parts of divinylbenzene, 1.2 parts of t-dodecyl mercaptan and 7 parts of magenta pigment (“C.I. Pigment Red 122”, trade name, manufactured by Clariant International Ltd.) were wet-pulverized using a media type dispersion apparatus (“PICO MILL”, trade name, manufactured by ASADA IRON WORKS. CO., LTD.). Then, 6 parts of charge control resin (a number average molecular weight: 7000, a weight average molecular weight: 22000, Mw/Mn=3.1), which was produced by polymerization of 2% 2-acrylamide-2-methylpropanesulfonic acid, and 10 parts of the parting agent obtained by the Production Example 1 were added to the wet-pulverized mixture. And, the mixture was mixed and dissolved to prepare a polymerizable monomer composition for core.

Separately, an aqueous solution containing 6.2 parts of sodium hydroxide dissolved in 50 parts of ion-exchanged water was gradually added to an aqueous solution containing 10.2 parts of magnesium chloride dissolved in 250 parts of ion-exchanged water, with stirring, to prepare a magnesium hydroxide colloidal dispersion.

And, 1.0 parts of methyl methacrylate, 0.5 parts of LIGHTACRYLATE PTMG-250 (trade name, manufactured by KYOEISHA CHEMICAL Co., Ltd.), 0.5 parts of methacrylate modified silicone oil (“X-22-2404”, trade name, manufactured by Shin-Etsu Chemical Co., Ltd.) and 65 parts of water were mixed to obtain an aqueous dispersion of polymerizable monomer for shell.

The polymerizable monomer composition for core obtained above was added to the colloidal dispersion of magnesium hydroxide obtained above at room temperature (25° C.), and the mixture was stirred until droplets stabilized. After the droplets stabilized, 6 parts of t-butyl peroxy-isobutyrate (“PERBUTYL IB”, trade name, manufactured by NOF CORPORATION) was added to the mixture, and then the mixture was stirred at 15,000 rpm under shearing force using a Ebara Milder (“MDN303V”, trade name, manufactured by Ebara Corporation) to form finer droplets of the polymerizable monomer mixture for core.

The colloidal dispersion of magnesium hydroxide in which the droplets of the polymerizable monomer composition were dispersed was charged into a reactor equipped with an agitating blade, and heated to 85° C. to initiate a polymerization reaction with maintaining the temperature at constant. At the time when the conversion of the monomer into a polymer reached almost 100%, 0.3 parts of water-soluble polymerization initiator (“VA-086”, trade name, manufactured by Wako Pure Chemical Industries, Ltd.) (2,2′-azobis-(2-methyl-N-(2-hydroxyethyl))propionamide) dissolved in the aqueous dispersion of the polymerizable monomer for shell was charged into the reactor. The polymerization reaction was further continued for 4 hours. After 4 hours, the polymerization reaction was stopped to obtain an aqueous dispersion of core-shell structured colored resin particles.

While stirring the aqueous dispersion of colored resin particles thus prepared at room temperature (25° C.), the aqueous dispersion was washed (at 25° C. for 10 minutes) using sulfuric acid such that the system has a pH value of 4.5 or lower. Then, after filtrating and dehydrating the aqueous dispersion and then drying, dry colored resin particles was obtained. To 100 parts of the dry colored resin particle, 0.5 parts of organic fine particle comprising a core layer of polystyrene and a shell layer of polymethyl methacrylate and having a volume average particle diameter of 0.35 μm was added as an external additive and stirred using HENSCHEL MIXER for 5 minutes at 1400 rpm at a temperature of an inside of the mixer of 55° C. Furthermore, while water-cooling a jacket of the mixer, 0.8 parts of silica (“Rx-200”, trade name, manufactured by NIPPON AEROSIL CO., LTD.) having a volume average particle diameter of 12 nm and 1.0 parts of another silica (“Rx-50”, trade name, manufactured by NIPPON AEROSIL CO., LTD.) having a volume average particle diameter of 40 nm were added to the mixture and stirred for 10 minutes at 1400 rpm to prepare a toner for developing electrostatic latent images. Property of the toner for developing electrostatic latent image and image quality of a printed image developed using the toner for developing electrostatic latent image were evaluated according to the above-mentioned manner. The results were shown in table 1.

### Example 2

In the same way as in Example 1, except that an amount of polymethacrylate ester macromonomer was exchanged to 1.5 parts and 0.5 parts of LIGHTACRYLATE PTMG-250 (trade name, manufactured by KYOEISHA CHEMICAL Co., Ltd.), 0.5 parts of methacrylate modified silicone oil (“X-22-2404”, trade name, manufactured by Shin-Etsu Chemical Co., Ltd.) and 65 parts of water were employed to obtain an aqueous dispersion of polymerizable monomer for shell, toner for developing electrostatic latent images was obtained. Property of the toner for developing electrostatic latent image, and image quality of a printed image developed using the toner for developing electrostatic latent image were evaluated as with Example 1. The results were shown in table 1.

### Comparative Example 1

To 100 parts of charge control resin (a weight average molecular weight: 20000, a glass transition temperature: 62° C.) produced by polymerizing 82% of styrene, 11% of butyl acrylate and 7% of 2-acrylamide-2-methylpropanesulfonic acid, 24 parts of methyl ethyl ketone and 6 parts of methanol were dispersed, and then the mixture was stirred by rolls under cooling. After the charge control resin was winded on the roll, 100 parts of magenta pigment (“C. I. Pigment Red 122”, trade name, manufactured by Clariant International Ltd.) was gradually added and kneaded for 1 hour to prepare a charge control resin compound. During this period, the clearance between the rolls was initially 1 mm, broadened gradually, to finally to 3 mm, and an organic solvent (a solvent mixture of methyl ethyl ketone/methanol=4/1) was added occasionally according to mixing and kneading condition of the charge control resin compound. Then, a part of the charge control resin compound was get out and dissolved in toluene to prepare a solution of 5% charge control resin compound in toluene. The solution was coated on a glass plate using a doctor blade having a clearance of 30 μm and then dried to obtain a sheet of the charge control resin compound.

A polymerizable monomer for core comprising 80 parts of styrene, 20 parts of n-butyl acrylate, 0.6 parts of divinylbenzene and 0.25 parts of polymethacrylate ester macromonomer (“AA6”, trade name, manufactured by Toagosei CO., LTD., Tg: 94° C.), 12 parts of the obtained charge control resin compound, 1 parts of t-dodecyl mercaptan and 10 parts of ester compound obtained by the Production Example 1 were dispersed by a bead mill under room temperature to prepare a polymerizable monomer composition for core.

Separately, in a container equipped with an agitating vessel, an aqueous solution containing 9.7 parts of sodium hydroxide dissolved in 50 parts of ion-exchanged water was gradually added to an aqueous solution containing 16.0 parts of magnesium chloride dissolved in 250 parts of ion-exchanged water, with stirring, to prepare a colloidal dispersion of magnesium hydroxide.

And, 2 parts of methyl methacrylate and 65 parts of water were subjected to a fine dispersion treatment using an ultrasonic emulsion machine to prepare an aqueous dispersion of polymerizable monomer for shell.

The polymerizable monomer composition for core was added to the colloidal dispersion of magnesium hydroxide obtained above, and the mixture was stirred until droplets stabilized. After the droplets stabilized, 5 parts of t-butyl peroxy-2-ethylhexanoate (“PERBUTYL O”, trade name, manufactured by NOF CORPORATION) was added to the mixture. Then, the obtained dispersion was passed through an Ebara Milder (“MDN303V”, trade name, manufactured by Ebara Corporation) equipped with an agitator rotating at 15000 rpm for a total holding time of 3 seconds. The dispersion passed through the Ebara Milder was injected to the agitating vessel again via an inner nozzle at an injection speed of 0.5 m/s for circulation to form droplets of the polymerizable monomer mixture for core. During the formation of the droplets, the tip of the inner nozzle was positioned at 50 mm under dispersion level in the agitating vessel and the circulation was performed for 10 times. The Ebara Milder was equipped with a jacket at its circumference into which cooling water of about 15° C. was flowed.

To the colloidal dispersion of magnesium hydroxide in which the droplets of the polymerizable monomer composition for core were dispersed, 1 parts of sodium tetraborate 10-hydrate was added and the mixture was charged into a reactor equipped with an agitating blade and heated to 85° C. to initiate a polymerization reaction with maintaining the temperature at 85° C. At the time when the conversion of the monomer into a polymer reached almost 100%, 0.2 parts of a water-soluble polymerization initiator (2,2′-azobis-(2-methyl-N-(2-hydroxyethyl)-propionamide, “VA-086”, trade name, manufactured by Wako Pure Chemical Industries, Ltd.) dissolved in the aqueous dispersion of the polymerizable monomer for shell was charged into the reactor. After the polymerization reaction was further continued for 4 hours, the reaction was stopped to obtain an aqueous dispersion of core-shell structured colored resin particles. The obtained aqueous dispersion of colored resin particles was washed (at 25° C., for 10 minutes) using sulfuric acid under stirring such that the system has a pH value of 4 or lower. After filtrating and dehydrating the aqueous dispersion, 500 parts of ion-exchanged water was newly added thereto to form a slurry again and then subjected to water washing.

Thereafter, dehydrating and water washing were repeatedly performed several times, and solids was separated from the aqueous dispersion and dried at 45° C. for two days and two nights using a dryer to prepare core-shell structured polymer particles.

To 100 parts of the core-shell structured polymer particles obtained above, 0.5 parts of silica (“Rx-300”, trade name, manufactured by NIPPON AEROSIL CO., LTD.) having a degree of hydrophobicity of 65% and a volume average particle diameter of 7 nm, 2.0 parts of another silica (“Rx-50”, trade name, manufactured by NIPPON AEROSIL CO., LTD.) having a degree of hydrophobicity of 64% and a volume average particle diameter of 40 nm and 0.3 parts of cube-shaped calcium carbonate (“CUBE-03BHS”, tradename, manufactured by MARUO CALCIUM CO., LTD.) having a volume average particle diameter of 0.3 μm were added as external additives and mixed for 10 minutes at 1,400 rpm using HENSCHEL MIXER to prepare toner for developing electrostatic latent images. Property of the color toner for developing electrostatic latent images and image quality of a printed image developed using the color toner were evaluated according to Example 1. The results were shown in table 1.

### Comparative Example 2

367.5 parts of propylene oxide adduct of bisphenol A, 146.4 parts of ethylene oxide adduct of bisphenol A, 126.0 parts of terephthalic acid, 40.2 parts of dodecenylsuccinic anhydride and 77.7 parts of anhydrous trimellitic acid were charged into a glass reactor, to which a thermometer, a stainless stirrer, a flow-down type condenser and a nitrogen gas introduction pipe were mounted, and heated with a heater to be reacted at 220° C. under air flow of nitrogen gas. A softening point was checked in accordance with ASTME28-67 for obtaining a degree of polymerization. And, when a softening point became 110° C., the polymerization reaction was stopped to obtain a resin A.

20.0 parts of the resin A obtained above and 3.5 parts of 2,2′-azobis isobutylnitryl were added to 65.0 parts of styrene, 35.0 parts of 2-ethylhexylacrylate, 0.9 parts of divinylbenzene, 7.0 parts of magenta pigment (“C. I. Pigment Red 122”, trade name, manufactured by Clariant International Ltd.) and 1.0 parts of charge control agent (“BONTRON E-84”, trade name, HODOGAYA CHEMICAL CO., LTD.), and the mixture was charged into atoriter (“MA-01SC”, trade name, manufactured by Mitsui Miike Kako Co., Ltd.) and dispersed for 5 hours at 10° C. to obtain a polymerizable compound. The procedure was performed without use of a parting agent. Then, 560 parts of a prepared solution of aqueous colloid of 4% tricalsium phosphate and 240 parts of the polymerizable compound obtained above were charged into another glass reactor and emulsion-dispersed using TK homomixer (“M type”, trade name, manufactured by Tokushu Kika Kogyo Corporation) at 12000 rpm for 5 minutes at 15° C.

Then, a reflux condenser, a thermometer, a nitrogen gas introduction pipe and a stainless stirrer were mounted to the glass reactor and further an electrothermal heater was mounted. With stirring under nitrogen gas atmosphere, the mixture contained in the glass reactor was heated to 85° C. to be reacted for 10 hours. After cooling, the dispersion medium was dissolved in about 440 parts of an aqueous solution of 1N hydrochloric acid and after filtrating and water washing, the dispersion medium was vacuum-dried at a pressure of 20 mmHg for 12 hours at 45° C. And, the dispersion medium was classified using a pneumatic separator to obtain colored resin particle having an average particle diameter of 8 μm and comprising an outer shell of amorphous polyester.

To 100 parts of the colored resin particles obtained above, 0.4 parts of hydrophobic silica fine powder (“Aerosil R-972”, trade name, manufactured by NIPPON AEROSIL CO., LTD.) was added and mixed to prepare toner for developing electrostatic latent images. Property of the toner for developing electrostatic latent images and image quality of a printed image developed using the color toner were evaluated according to Example 1. The results were shown in table 1.

TABLE 1

| | Ex. 1 | Ex. 2 | Co. Ex. 1 | Co. Ex. 2 |
|---|---|---|---|---|
| <Property of Toner | | | | |
| for Developing | | | | |
| Electrostatic | | | | |
| Latent Images> | | | | |
| Volume Average | 6.7 | 6.8 | 7.4 | 8.0 |
| particle | | | | |
| diameter(μm) | | | | |
| Particle diameter | 1.22 | 1.20 | 1.24 | 1.23 |
| distribution (Dv/Dp) | | | | |
| Average circularity | 0.973 | 0.975 | 0.966 | 0.955 |
| Arithmetic average | 0.19 | 0.21 | 0.22 | 0.10 |
| roughness Ra (μm) | | | | |
| 10-point average | 0.65 | 0.75 | 0.42 | 0.21 |
| roughness Rz (μm) | | | | |
| Angle of repose (°) | 27 | 26 | 44 | 42 |
| Microcompression | 10 | 13 | 0.3 | 23 |
| transformation | | | | |
| ratio (%) | | | | |
| Zeta potential | | | | |
| E1 (mV) | 24.2 | 26.4 | 25.3 | 34.2 |
| E2 (mV) | 23.3 | 23.6 | 20.2 | 26.0 |
| difference between | 0.90 | 2.80 | 5.10 | 8.20 |
| E1 and E2 (mV) | | | | |
| Parting Agent | | | | |
| Hydroxy Value (a) | 0.6 | 0.6 | 0.6 | — |
| addition amount (b) | 10 | 10 | 10 | — |
| a × b | 6 | 6 | 6 | — |
| Glass transition | 55.6 | 56.2 | 57.2 | 28.5 |
| temperature (° C.) | | | | |
| <Property of | | | | |
| Printed image> | | | | |
| Fixing temperature | 130 | 130 | 130 | 125 |
| (° C.) | | | | |
| Hot-offset | 200 | 200 | 190 | 170 |
| temperature (° C.) | | | | |
| Image density | 1.56 | 1.50 | 1.55 | 1.51 |
| Starting After | 1.43 | 1.40 | 1.30 | 1.20 |
| 2 weeks | | | | |
| Environmental | | | | |
| Durability | | | | |
| N/N (sheets) | 10,000 | 10,000 | 8,500 | 8,500 |
| H/H (sheets) | 8,500 | 8,500 | 7,000 | 6,000 |
| Shelf stability (%) | 3 | 5 | 17 | 36 |
| Cleaning Property | 10,000 | 9,500 | 9,000 | 7,000 |
| (sheets) | | | | |

The results of the evaluation of the toners for developing electrostatic latent image shown in the table 1 show the following facts.

The toner for developing electrostatic latent images of the Comparative Example 1, in which an angle of repose and a 10-point average roughness of a surface of the toner were outside of the scope of the present invention, and the toner for developing electrostatic latent images of the Comparative Example 2, in which an angle of repose, a 10-point average roughness of a surface of the toner and a microcompression transformation ratio were outside of the scope of the present invention, show low hot-offset temperature, low image density of the printed image using the toners, especially the toners after allowed to stand under a condition of a temperature of 50° C. and a humidity of 80% for 2 weeks. Furthermore, the toners have less environmental durability, shelf stability and also cleaning property.

On the contrary, the toners for developing electrostatic latent images of the Examples 1 to 2 according to the present invention show high hot-offset temperature and high image density, and also excellent environmental durability, shelf stability and cleaning property.

What is claimed is:

1. A toner for developing electrostatic latent images comprising a colored resin particle containing a binder resin, a colorant and a parting agent, and an external additive,
wherein a volume average particle diameter (Dv) is 4 to 10 μm and an average circularity is in the range of 0.93 to 0.995;
an arithmetic average roughness Ra of a surface of the toner is in the range of 0.05 to 0.3 μm;
a 10-point average roughness of the surface of the toner is in the range of 0.5 to 2.5 μm;
an angle of repose is in the range of 10 to 350; and
a transformation ratio of the toner applied with a pressure of 1 mN/mm² for 5 seconds by means of a microcompression tester is 20% or less.

2. The toner for developing electrostatic latent image according to claim 1,
wherein an absolute zeta potential (E1) of the toner after allowed to stand for 24 hours at a condition of 23° C. and a humidity of 50% is in the range of 0 to 40 mV, and
a difference between an absolute zeta potential (E2) of the toner after allowed to stand for 2 weeks at a condition of 50° C. and a humidity of 80% and E1 is smaller than 5 mV.

3. The toner for developing electrostatic latent images according to claim 1,
wherein the parting agent is a multifunctional ester compound having a hydroxy value (a) from 0.01 to 3 mgKOH/g, and a product (a×b) of the hydroxy value (a) (unit: mgKOH/g) and an addition amount (b) (unit: parts by weight) of the parting agent per 100 parts by weight of the binder resin is 0.05 to smaller than 40.

4. The toner for developing electrostatic latent image according to claim 1,
wherein a glass transition temperature is 50 to lower than 70° C.

5. The toner for developing electrostatic latent image according to claim 1,
wherein said parting agent is a multifunctional ester compound having an acid value of 10 mgKOH/g or less.

6. The toner for developing electrostatic latent image according to claim 1,
wherein said parting agent is a multifunctional ester compound soluble in 100 parts by weight of styrene at 25° C. in an amount of 5 parts by weight or more.

7. The toner for developing electrostatic latent image according to claim 1,
wherein the colored resin particle further contains a charge control agent.

8. The toner for developing electrostatic latent image according to claim 7,
wherein the charge control agent contains a charge control resin.

9. The toner for developing electrostatic latent image according to claim 8,
wherein the charge control resin has a glass transition temperature in the range of 40 to 80° C.

10. The toner for developing electrostatic latent image according to claim 1,
wherein a volume average particle diameter (Dv) is in the range of 5 to 8 μm.

11. The toner for developing electrostatic latent image according to claim 1,
wherein an average circularity is in the range of 0.95 to 0.995.

12. The toner for developing electrostatic latent image according to claim 1,
wherein a ratio (Dv/Dp) of a volume average particle diameter (Dv) to a number average particle diameter (Dp) is in the range of 1.0 to 1.3.

13. The toner for developing electrostatic latent image according to claim 1,
wherein the external additive contains silica fine particle (A) having a primary volume average particle diameter in the range of 5 to 18 nm.

14. The toner for developing electrostatic latent image according to claim 13,
wherein the external additive further contains organic fine particle or inorganic fine particle having a primary volume average particle diameter in the range of 0.1 to 1 μm.

15. The toner for developing electrostatic latent image according to claim 14,
wherein the external additive further contains silica fine particle (B) having a primary volume average particle diameter in the range of 20 to 60 nm.

16. The toner for developing electrostatic latent image according to claim 13,
wherein an addition amount of the silica fine particle (A) is 0.1 to 3 parts by weight per 100 parts by weight of the colored resin particle.

17. The toner for developing electrostatic latent image according to claim 15,
wherein an addition amount of the silica fine particle (B) is 0.1 to 2 parts by weight per 100 parts by weight of colored resin particle.

18. The toner for developing electrostatic latent image according to claim 1,
wherein the colored resin particle is produced by a polymerization reaction.
